(19) United States
(12) Patent Application Publication
(10) Pub. No.: US 2015/0135781 A1
(43) Pub. Date: May 21, 2015

(54) LOCKING SYSTEM

(71) Applicants: ALEXANDER KLEINER, QIRYAT GAT (IL); GRIGORY ORENBAKH, QIRYAT GAT (IL)

(72) Inventors: ALEXANDER KLEINER, QIRYAT GAT (IL); GRIGORY ORENBAKH, QIRYAT GAT (IL)

(21) Appl. No.: 14/084,801

(22) Filed: Nov. 20, 2013

(51) Int. Cl. E05B 63/00; E05B 35/00; E05B 13/00

(52) U.S. Cl. CPC E05B 63/0065; E05B 13/00; E05B 35/00; E05B 2063/0082
USPC 70/344

(57) ABSTRACT

The present invention relates to locking systems in general and in particular to locking systems that can be locked so that they cannot be opened even with a genuine key.

The present invention further relates to a method for locking a locking system comprising a lock cylinder connected to a bolt such that it cannot be opened with any key, including with the original, genuine key, the method comprising the steps of:

(i) adding a control lever to any cogwheel or cam connecting the lock cylinder to the bolt;

(ii) moving the control lever such that the cogwheels or cams connecting the lock cylinder to the bolt are misaligned;

wherein the lock cylinder is no longer connected to the bolt and moving the genuine key inside the lock cylinder does not move the bolt.

### TECHNICAL FIELD

The present invention relates to locking systems and methods in general and in particular to locking methods and systems that can be locked so that they cannot be opened even with a genuine key.

### BACKGROUND ART

Almost every exterior house or office door in the world can be locked by some type of locking system. Most locking systems are operated by a key that is inserted into a cylinder lock, such that turning the key in one direction locks the door by moving a bolt inside the door frame, and moving the key in the other direction releases the bolt from the door frame so that the door can be opened.

Many alternatives and variations exist to the basic locking configuration just described. For example, instead of one bolt, the locking system can have multiple bolts that enter the door frame and ground so that the door can be less easily forced open. Instead of a key, the lock can be operated by electrical or electronic means such as by swiping a card, via a remote control that operates an electromagnet that can move the bolt etc. Very sophisticated systems may also use biometric identification such as finger prints or iris reading in order to only let authorized people open the locking systems.

All these locking systems have one characteristic in common; they all enable to open the door only with genuine access that is using a genuine key, a genuine card, genuine biometric identification etc. All these systems will always let someone with the right key open the door. Only keys that do not match the locking cylinder will not be able to open the door.

It may happen that unwanted people gain access to a genuine key, for example, if one the people in the house holds has lost the key or if the key has been stolen. In other instances, unwanted people may manage to duplicate a genuine key. Thus for security system, there is a need to create a locking system that can be locked in such a way that the door cannot be opened with any key, including with

the genuine key. For example, when going to sleep, it would be preferable and more secure to lock the front door so that it cannot be opened from outside with any key including a copy of the genuine key or even with the genuine key itself. U.S. Pat. Nos. 4,384,465, 6,007,117 and 4,625,848 discloses different locking systems, though none of them can prevent a genuine key from opening the door.

### SUMMARY OF INVENTION

It is an object of the present invention to present a locking system that can be locked such that even the original genuine key cannot unlock the system.

The present invention thus relates to a locking system, comprising:
(i) a lock cylinder with a cavity for inserting a genuine key;
(ii) a bolt whose movement locks or unlocks said locking system;
(iii) one or more cogwheels or cams aligned to connect said lock cylinder and said bolt such that movement of the genuine key inside the lock cylinder in one direction or the other moves the bolt to lock or unlock the locking system; and
(iv) a control lever coupled to a cogwheel or cam of said one or more cogwheels,

wherein moving said control lever misaligns said coupled cogwheel or cam such that the lock cylinder is no longer connected to the bolt and moving the genuine key inside the lock cylinder does not move the bolt.

In some embodiments, the one or more cogwheels or cams comprise an intermediate cogwheel connected to said lock cylinder via a cylinder cogwheel and a bolt cogwheel connecting said bolt and said intermediate cogwheel.

In some embodiments, the control lever is moved manually.

In some embodiments, the control lever movement is achieved by an electromagnet operated by a remote control unit.

In some embodiments, the control lever is moved both manually and electrically.

In some embodiments, the control lever is coupled to the intermediate cogwheel.

In some embodiments, the thickness of all the cogwheels is not identical.

In some embodiments, the intermediate cogwheel is thinner that said cylinder cogwheel.

The present invention further relates to a method for locking a locking system comprising a lock cylinder connected to a bolt such that it cannot be opened with any key, including with the original, genuine key, the method comprising the steps of:
(i) adding a control lever to any cogwheel or cam connecting the lock cylinder to the bolt;
(ii) moving the control lever such that the cogwheels or cams connecting the lock cylinder to the bolt are misaligned;

wherein the lock cylinder is no longer connected to the bolt and moving the genuine key inside the lock cylinder does not move the bolt.

### BRIEF DESCRIPTION OF DRAWINGS

FIG. 1 shows a lock cylinder connected to an intermediate cogwheel in which in turn is connected to the bolt cogwheel.

FIGS. 2A-2B show a rear view of an embodiment of a lock of the invention wherein the intermediate cogwheel is disconnected from the bolt cogwheel. FIG. 2B is a close-up of section A shown in FIG. 2A.

FIGS. 3A-3B are a rear view of an embodiment of a lock of the invention wherein the intermediate cogwheel is connected to the bolt cogwheel. FIG. 3C is an enlargement of the ring. FIGS. 3D-3E are enlargements of the spindle.

FIG. 4 is a side view of the locking system of the invention along with common locking system components.

FIG. 5 is an isometric view of the locking system of the invention along with common locking system components.

FIG. 6 is an embodiment of a mass production multiple-latch locking system that can be adapted according to the invention.

FIGS. 7A-7C illustrate an embodiment of a locking system according to the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

Most locking systems today for houses and apartments use a cylinder lock. In the cylinder lock, a fitted, genuine key turns a cylinder, or plug, which turns an attached cam or cogwheel further connected (in many possible ways) to a bolt. When the plug is turned one way, the cam pulls in on the bolt and the door can open. In spring-driven latch systems, when the plug turns the other way, the cam releases the bolt and a spring snaps it into place so the door cannot open. In a deadbolt lock system, there is no spring mechanism—the turning cylinder slides the bolt forward and backward. A deadbolt is more secure than a spring-driven latch since it's much harder to push the bolt in from the side of the door. All key-based locking systems are based on the concept that turning the genuine (fitted) key inserted into the lock cylinder cavity, moves the bolt to lock or unlock the door depending on the direction the genuine key is turned. If an attempt is made to enter the wrong key into the cylinder cavity, then it is possible that the wrong key may not fit entirely or even partially into the cylinder cavity. If the wrong key is sufficient close to the genuine key, than the wrong key might enter partially or completely into the cylinder lock cavity, but the wrong key will not be able to turn sufficiently in order to move the bolt.

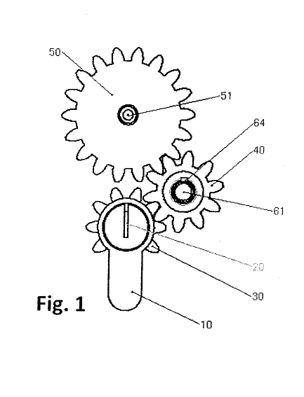

Reference is now made to FIG. 1 showing an embodiment of a basic locking system configuration of the art. A lock cylinder 10 comprises a cavity 20 wherein a genuine key can be inserted and turned both clockwise and counterclockwise. The lock cylinder 10 comprises a cylinder cogwheel 30 or alternatively a cam in order to translate the cylinder's rotational movement into a force that can eventually move the bolt (not shown) to lock or unlock the system.

It is well known in the art that the lock cylinder 10 may be connected to the bolt in many variations including but not limited to combinations of cams, cogwheels and springs. In the exemplary embodiment shown in FIG. 1, the cylinder cogwheel 30 is connected to an intermediate cogwheel 40 turning on a spindle 61, and the intermediate cogwheel 40 is in turn connected to a bolt cogwheel 50 turning on an axis 51, connected to a bolt (not shown). Thus moving the genuine key in the lock cylinder 10 moves the cylinder cogwheel 30 which in turn moves the intermediate cogwheel 40 which turn moves the bolt cogwheel 50 which is connected to a second bolt cogwheel or cam (not shown) which in turn moves the bolt. The spindle 61 goes through an opening in the middle of the intermediate cogwheel 40, and is loosely fitted inside. In some embodiments, a stopper 64 is placed on top of the spindle 61 so that the spindle 61 is prevented from a rotational movement and is only allowed a forward and backward movement. Thus when the intermediate cogwheel 40 rotates, the spindle 61 is prevented from rotation by the stopper 64.

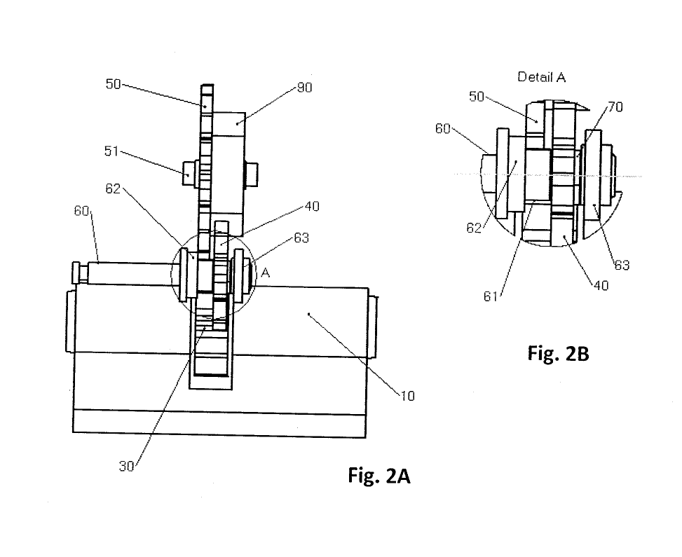

Reference is now made to FIG. 2A. A control lever (shaft) 60 is connected to the spindle 61 that goes through an opening in the middle of the intermediate cogwheel 40. There are many ways known in the art how to couple a shaft to a spindle. In some embodiments, the control lever 60 is screwed into the spindle 61. The control lever 60 is placed at one side of the intermediate cogwheel 40, so it is accessible by a user from inside the house. Preferably, movement of the intermediate cogwheel 40 does not move the control lever 60. However, movement of the control lever 60 moves the intermediate cogwheel 40 not along its rotational axis, but shifts the intermediate cogwheel 40 along any axis that misaligns the intermediate cogwheel 40 from any one or more cogwheels it is connected to. Preferably, the control lever 60 movement is a substantially horizontal movement, and thus movement of control lever 60 moves the intermediate cogwheel 40 along a substantially axis too. Typically, the intermediate cogwheel 40 is moved along the axis of the control lever 60 and the coupled the spindle 61 thus along a substantially horizontal axis. Moving the control lever 60 thus misaligns the intermediate cogwheel 40 such that the lock cylinder 10 is no longer connected to the bolt and moving the cylinder even with a genuine key inside the lock cylinder 10 does not move the bolt.

The control lever 60 can be connected in different ways to a cogwheel, such that the control lever 60 can move the cogwheel on one axis but movement of the cogwheel on its rotational axis does not move the control lever 60.

In some embodiments, bushings (metal inserts) shown as 62 and 63 are placed on one or both sides of the intermediate cogwheel 40 such that the spindle 61 can go through the two bushings 62 and 63. Typically, the two bushings 62 and 63 are placed one 62 on the lock's cover and the other 63 on the lock's frame.

FIG. 2A shows an embodiment of a ring 70 installed on top of the spindle 61 in close proximity to the intermediate cogwheel 40, for example, one to three tenths of a millimeter away. The ring 70 is fixated on top of the spindle 61 either by movable means or permanently. Thus when pulling on the control lever 60, the ring 70 comes in contact with the intermediate cogwheel 40 and pulls it in the direction of the movement of the control lever 60. In some embodiments, the ring 70 can be hard pressed into a groove on the spindle 61.

Using a ring 70 is one practical method for installing a hinge that can pull the intermediate cogwheel 40, though it would be obvious for any person skilled in the art to replace the ring 70 with many alternatives known in the art, and all these alternatives are encompassed by the invention. For example, the ring 70 can be replaced with a pin or cam removably or permanently attached to the spindle 61. It is also possible to make the diameter of the spindle 61 extending out of the intermediate cogwheel 40 larger than the diameter of the hole in the middle of the intermediate cogwheel 40 in one or both sides of the intermediate cogwheel 40. The solution where both extending sides of the spindle 61 are larger than the diameter of the intermediate cogwheel 40 hole would work well technically, but would be more complicated to put in place requiring either the spindle 61 or the intermediate cogwheel 40 to be made in two parts that would come together after installation. For example, the spindle 61 can be made in two parts, each part comprising the larger diameter portion extending out of the intermediate cogwheel 40 that can be screwed together inside the intermediate cogwheel 40. This type of solutions presents the risk of being possibly more expensive to manufacture and assemble while being less robust since the two pieces have the risk of breaking apart with time, possibly creating a malfunction in the locking system.

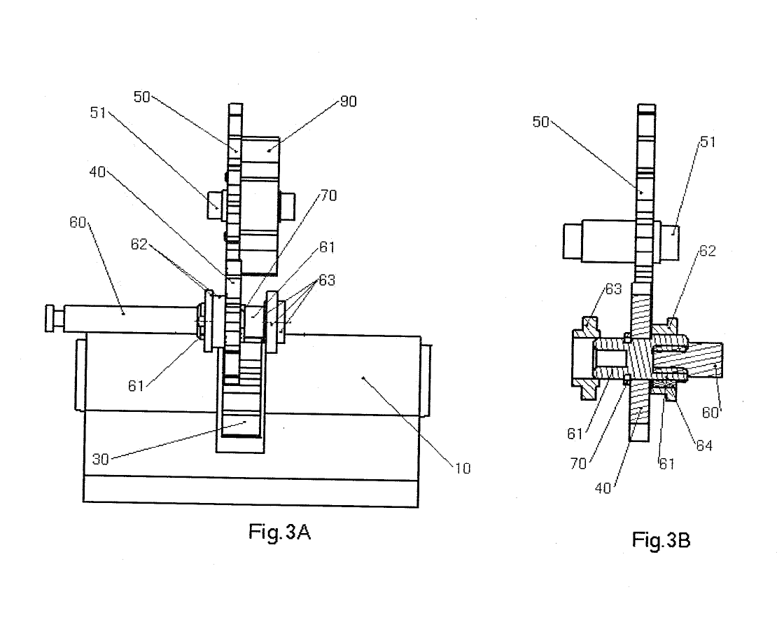

FIG. 2A shows the locking system in a position where the intermediate cogwheel 40 is misaligned relative to the bolt cogwheel 50. This position, sometimes referred to as “night mode” or “safe mode”, assures that the bolt cannot be moved even when inserting a genuine key in the cylinder lock 10. When the control lever 60 is pulled (from right to left on FIG. 2A) the intermediate cogwheel 40 is also pulled until it reaches bushing 62. When the intermediate cogwheel 40 reaches bushing 62, the intermediate cogwheel 40 is aligned under the bolt cogwheel 50 (as shown in FIG. 3A).

When pulling on the control lever 60 (leftwards on FIG. 2A) a stopping mechanism needs to be put in place so that the intermediate cogwheel 40 stops below the bolt cogwheel 50. A person skilled in the art would immediately be able to devise additional methods (beyond the bushings 62, 63), for example, stoppers can be installed on the control lever 60 such that its movement is limited horizontally between two positions corresponding to alignment and misalignment of the intermediate cogwheel 40.

As can be seen in FIG. 2A, the width of the different cogwheels 30, 40 and 50 is not identical, the cylinder cogwheel 30 being wider than the two other cogwheels 40 and 50. The different cogwheels and cams used may be of identical or of different sizes. In the configuration shown in FIG. 2A, the control lever 60 has been pushed such that the intermediate cogwheel 40 is no longer aligned under the bolt cogwheel 50. This cogwheel misalignment means that when the genuine key is turned, the cylinder cogwheel 30 (or cam) will move the intermediate cogwheel 40 but movement of the intermediate cogwheel 40 will not have any effect on the bolt cogwheel 50. It can be said that the genuine key “will turn on empty”, unable to unlock the bolt.

FIG. 2B is a close-up of section A in FIG. 2A. FIG. 2B shows in greater detail how the spindle 61 extends through the intermediate cogwheel 40 on both sides, and how the spindle 61 goes through the bushings 62, 63. The ring 70 is placed on spindle 61 on the opposite side of the control lever 60 (in the embodiment shown).

It is important to understand that according to the invention the control lever 60 is required in order to mechanically misalign or disconnect the lock cylinder 10 from the bolt so that turning the genuine key does not move the bolt. The actual connection of the control lever 60 may be any cogwheel or even the lock cylinder 10 or the bolt.

The control lever 60 may be a mechanical implementation where the user moves the control lever 60 manually. Alternatively, the control lever 60 may be implemented using electrical or electronic means, for example, a remote control may activate an electromagnet that can move a cogwheel, such as the intermediate cogwheel 40. In a mechanical implementation, the control lever 60 may be activated only from inside the house, but if the control lever 60 is an electrical or electronic one, the user may activate the control lever 60 via the remote control also when exiting the house.

Reference is now made to FIG. 3A wherein the locking system allows the genuine key's movement to move the bolt. As can be seen, and unlike the configuration of FIG. 2A, the control lever 60 has been moved such that the intermediate cogwheel 40 is aligned under the bolt cogwheel 50. This cogwheel alignment means that when the genuine key is turned, the cylinder cogwheel 30 (or cam) will move the intermediate cogwheel 40 which will move the bolt cogwheel 50 and cause the bolt to move.

In order for the alignment and misalignment of the intermediate cogwheel 40 and the bolt cogwheel 50 to succeed in a smooth as possible manner over time, it is possible to implement one or more facilitating procedures such as increasing the angle of the dents of the two cogwheels 40, 50 so that they can more easily fit together; make the dents that are to come together with a pointed edge so that they can more easily fit together. It would be clear for any person skilled in the art to devise additional methods to insure the smooth alignment and misalignment of cogwheels over time, and all these methods are encompassed by the invention.

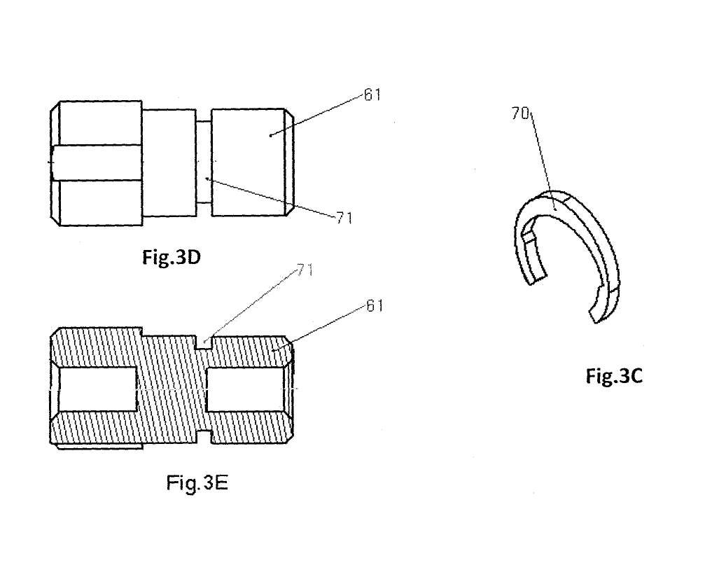

A bolt cam 90 component can be attached to the bolt cogwheel 50 in order to stabilize the bolt 80, as is explained below in reference to FIG. 4.

FIG. 3B shows in greater detail how the intermediate cogwheel 40 is aligned under the bolt cogwheel 50. The intermediate cogwheel 40 can rotate on its own axis, but cannot move sideways since it is blocked on one side by the ring 70 and on the other side by the larger diameter of the spindle 61. The only way to move the intermediate cogwheel 40 sideways is by pulling or pushing the control lever 60. The control lever 60 can moved until the intermediate cogwheel 40 touches bushing 62 or the ring 70 touches bushing 63. Stopper 64 is placed such that it prevents the spindle 61 from rotation along its axis.

In some embodiments, and as shown in FIG. 3B, the spindle 61 has two cavities in its extremes, wherein the control lever 60 fits in one of the two cavities, for example, by way of a screw or any other attaching mechanism. Also shown in the embodiment of FIG. 3B is how the spindle 61 can have two different diameters, wherein on the side of the control lever 60 the spindle's 61 diameter is larger than the diameter of the spindle' 61 portion which goes through the intermediate cogwheel 40.

FIG. 3C is a close-up of the ring 70 which in some embodiments is not a full circle but rather shaped like a horseshoe so that it can be easily attached to the groove 71 by applying pressure. FIGS. 3D-3E are a close-up of the spindle 61, showing the groove 71 into which the ring 70 is forced into.

Reference is now made to FIG. 4 wherein an embodiment of the locking system is viewed in its integrity. When the genuine key is turned inside the lock cylinder 10 cavity 20, the cylinder cogwheel 30 (or cam) will move the intermediate cogwheel 40 which will move the bolt cogwheel 50 and cause the bolt 80 to move inside and outside the door frame. Also shown is a bolt stopper 101 which is connected to the bolt stopper frame 100. The bolt stopper 101 is a protrusion that fits into a bolt cavity on top of the bolt 80. The bolt stopper frame 100 is connected to a spring (not shown) such the bolt stopper frame 100 moves up and down as a result of the movement of the bolt cam 90. When the bolt cam 90 goes down the pressure of the spring helps to secure the bolt stopper 100 in the bolt cavity. A second bolt cavity 103 can also be used into which the bolt 80 is fitted, again for stabilizing the bolt 80.

Pins 91 are used to attach the bolt cogwheel 50 to the bolt cam 90.

Also shown in FIG. 4 are additional components which are typical of locking systems such as holes 17 into which screws can be inserted for closing the locking system cover; a cylinder socket 11; pins 16 for closing the locking system frame and cover; and rollers 81 for leading the bolt 80 in the desired direction.

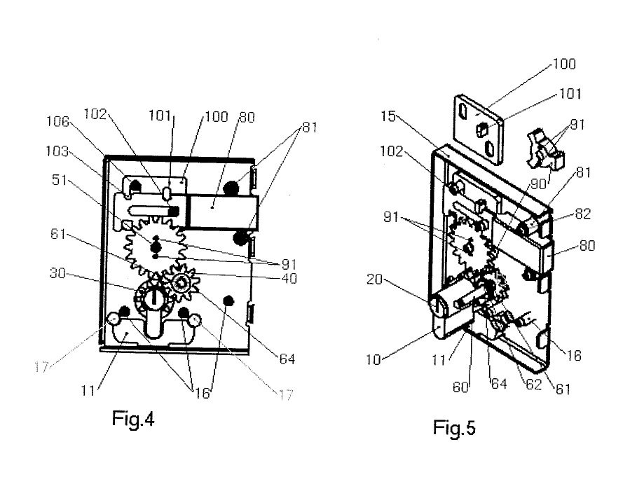

Reference is now made to FIG. 5 showing another view of an embodiment of a locking system inside the lock frame 15. In some embodiments, the bolt cam 90 is coupled behind the bolt cogwheel 50 and its role is to transfer the rotational movement of the bolt cogwheel 50 to the momentum of the bolt 80.

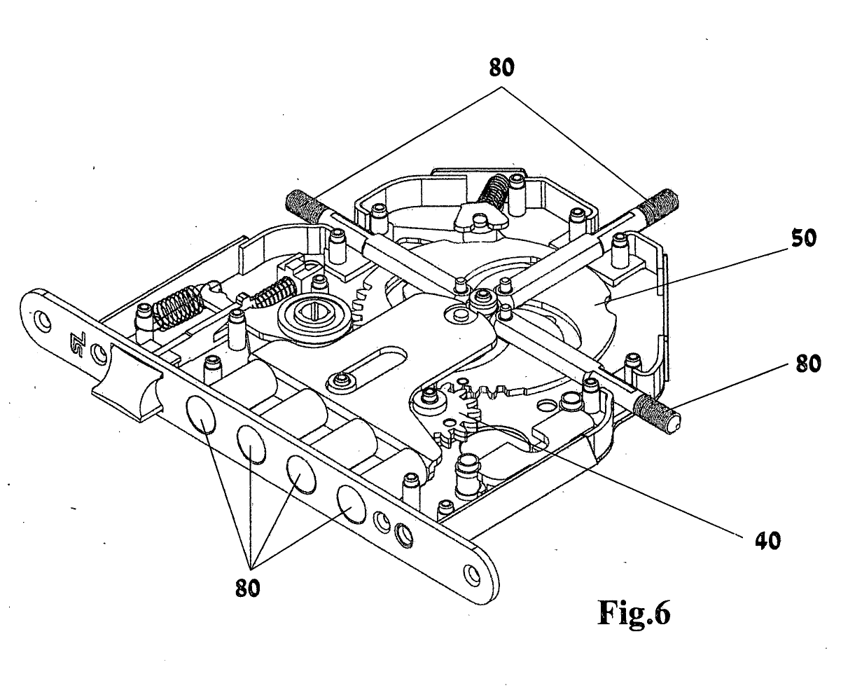

FIG. 6 shows a locking system with 3 bolts 80. All 3 bolts 80 are activated by a combination of cogwheels through movement of a genuine key in the cylinder lock 10 cavity 20. According to the invention, misaligning one cogwheel will have the effect that turning the cylinder will not move any of the 3 bolts 80.

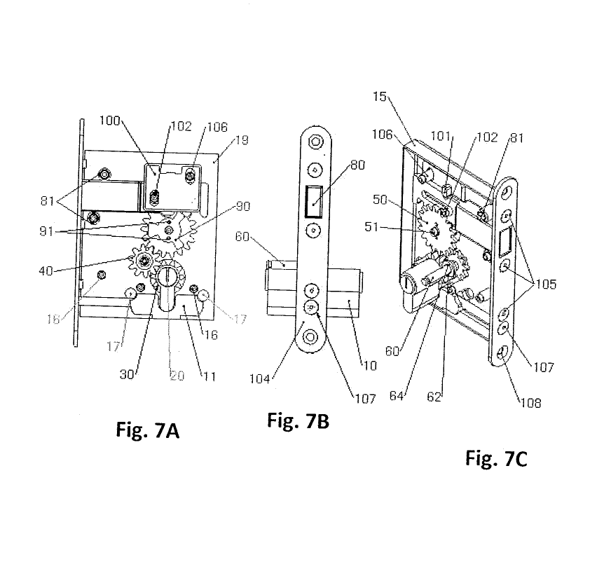

FIG. 7A is a side view of an embodiment of a locking system. Bolt cam 90 is shown attached behind the bolt cogwheel 50.

FIG. 7B shows the lock door cover 104 from which the bolt 80 emerges and retreats to and from the door frame. The Cylinder 10 is secured to the lock door cover 104 via a dedicated cylinder screw 107. FIG. 7C is an isometric view of the same locking system.

1. A locking system, comprising:
(i) a lock cylinder with a cavity for inserting a genuine key;
(ii) a bolt whose movement locks or unlocks said locking system;
(iii) one or more cogwheels or cams aligned to connect said lock cylinder and said bolt such that movement of the genuine key inside the lock cylinder in one direction or the other moves the bolt to lock or unlock the locking system; and
(iv) a control lever coupled to a cogwheel or cam of said one or more cogwheels or cams, wherein moving said control lever misaligns said coupled cogwheels or cams such that the lock cylinder is no longer connected to the bolt and moving the genuine key inside the lock cylinder does not move the bolt and the locking system cannot be opened with any key, including with the original, genuine key.

2. The locking system according to claim 1, wherein said one or more cogwheels or cams comprise an intermediate cogwheel connected to said lock cylinder via a cylinder cogwheel and a bolt cogwheel connecting said bolt and said intermediate cogwheel.

3. The locking system according to claim 1, wherein the control lever is moved manually.

4. The locking system according to claim 1, wherein the control lever movement is achieved by an electromagnet operated by a remote control unit.

5. The locking system according to claim 2, wherein said control lever is coupled to the intermediate cogwheel.

6. The locking system according to claim 2, wherein said intermediate cogwheel is thinner that said cylinder cogwheel.

7. A method for locking a locking system comprising a lock cylinder connected to a bolt such that it cannot be opened with any key, including with the original, genuine key, the method comprising the steps of:
(i) adding a control lever to any cogwheel or cam connecting the lock cylinder to the bolt;
(ii) moving the control lever such that the cogwheels or cams connecting the lock cylinder to the bolt are misaligned;
wherein the lock cylinder is no longer connected to the bolt and moving the genuine key inside the lock cylinder does not move the bolt and thus the genuine key cannot open the lock.

8. The locking method according to claim 7, comprising an intermediate cogwheel connected to said lock cylinder via a cylinder cogwheel and a bolt cogwheel connecting said bolt and said intermediate cogwheel.

9. The locking method according to claim 7, wherein the control lever is moved manually.

10. The locking method according to claim 7, wherein the control lever movement is achieved by an electromagnet operated by a remote control unit.

11. The locking method according to claim 8, wherein said control lever is coupled to the intermediate cogwheel.

12. The locking method according to claim 8, wherein said intermediate cogwheel is thinner that said cylinder cogwheel.
